(19) United States
(12) Patent Application Publication
(10) Pub. No.: US 2022/0162401 A1
(43) Pub. Date: May 26, 2022

(54) CROSSLINKING AGENTS FOR POLYMERIC SYSTEMS

(71) Applicant: Henkel AG & Co, KGaA, Duesseldorf (DE)

(72) Inventors: Michael Klotz, Edingen-Neckarhausen (DE); Ralf Sauer, St. Leon-Rot (DE); Fiona Cappel, Sandhausen (DE)

(21) Appl. No.: 17/667,602

(22) Filed: Feb. 9, 2022

Related U.S. Application Data
(63) Continuation of application No. PCT/EP2020/074421, filed on Sep. 2, 2020.

(30) Foreign Application Priority Data
Sep. 5, 2019 (EP) 19195499.9

(51) Int. Cl. C08J 3/24; C25D 13/08; C08K 5/205; C08K 3/06; C08K 5/47

(52) U.S. Cl. CPC C08J 3/24; C25D 13/08; C08F 4/20; C08K 3/06; C08K 5/47; C08K 5/205

(57) ABSTRACT

The present invention relates to a crosslinking agent for polymeric systems, which crosslinking agent comprises elemental sulfur, phenolic resin, thiazole disulfide compounds and metal salts based on thiocarbamates, and to the use thereof in vehicle manufacture.

The present invention relates to a crosslinking agent for polymeric systems, which crosslinking agent comprises elemental sulfur, phenolic resin, thiazole disulfide compounds and metal salts based on thiocarbamates, and to the use thereof in vehicle manufacture.

Manufacturing an automobile requires a great deal of technical resources and employees. The vehicles are usually manufactured in line production, in which the unfinished vehicle goes through numerous stations, at each of which a few work steps are carried out that further complete the car. For example, the body is first assembled from metal sheets using spot welding or adhesive technology to form the body shell, which is then coated in a subsequent step, the coating also comprising several steps. In order to arrive at the finished coated body, one or more dip baths are usually passed through, in which the body is first protected against corrosion. A filler is then applied, which allows the topcoat to be applied evenly, which gives the vehicle the desired color and which is then sealed with a clear coat. In vehicle assembly, all missing components are added to the coated body. Line production, valued for its efficiency, presents the challenge that the chemical components used in the individual steps must be compatible with the components in the other steps. For example, the adhesive that is used in the manufacture of the body shell must not react with the paints used for coating, and the adhesives that are used to attach cladding must not react with the paints, but at the same time should adhere thereto.

Due to the matching of the individual components with one another, every change in the process sequence requires a review and optionally renewed matching of the individual components. For example, after an improvement in the dip coating systems, in which the conventional tin catalysts were replaced by bismuth catalysts in order to reduce the curing temperature of the paints, sulfur-curing adhesives that were applied to the paints no longer exhibited the usual performance and quality, because the bismuth catalysts reacted with the sulfur, which led either to uncured paints at the points where the adhesive was applied, which made these points very susceptible to corrosion, or to the formation of bismuth sulfide, which resulted in defects and imperfections in the topcoats and clear coats formed.

Since the industry does not want to forego the advantages associated with the use of bismuth-based catalysts, there is a need for systems, in particular for adhesive systems, which are compatible with the improved catalysts and modified process sequences.

It is therefore the object of the present invention to provide a system, in particular an adhesive system, which has a high tolerance to bismuth, is compatible with bismuth catalysts, and can be incorporated into the established processes of vehicle manufacture.

It has surprisingly been found that this object is achieved by a crosslinking agent which, in addition to elemental sulfur and phenolic resin, comprises thiazole disulfide compounds and metal salts based on thiocarbamates.

A first object of the present invention is therefore a crosslinking agent for polymeric systems, comprising

a) elemental sulfur;

b) one or more phenolic resins;

c) one or more thiazole disulfide compounds; and

d) one or more metal salts based on thiocarbamates.

The crosslinking agent according to the invention showed good compatibility with the bismuth catalysts used in the dip coating of vehicle bodies and could be applied to substrates coated accordingly without restricting performance.

Sulfur-containing crosslinking systems often have the disadvantage that they have a high emission rate of sulfur, which, in addition to the health impact during use, means that products that are manufactured using sulfur-containing crosslinking systems, for example rubber products, have an unpleasant odor, which makes them unusable for applications in closed spaces, such as the vehicle interior. In contrast to conventional systems, the crosslinking agent according to the invention showed little to no emission of sulfur, which not only reduces the health risk, but also extends the areas of application of the crosslinking agent according to the invention.

The crosslinking agent according to the invention can be used, for example, for curing polymeric systems. The degree of crosslinking of the polymer can be controlled by the amount of active component in addition to the duration of the polymerization. Depending on the application, a high or low degree of crosslinking may be desired. However, the content of sulfur as an active component should not be too high, in order to avoid sulfur emissions. It was surprisingly found that even with a comparatively high content of sulfur in the crosslinking agent according to the invention, the sulfur emission observed in other systems could be largely avoided. In the context of the present invention, it has proven to be advantageous in this regard if the amount of sulfur in the crosslinking agent is no more than 5 wt. %. An embodiment is therefore preferred in which the crosslinking agent according to the invention has 1 to 5 wt. %, preferably 1.5 to 4 wt. %, of elemental sulfur, in each case based on the total weight of the crosslinking agent.

The crosslinking agent according to the invention furthermore comprises at least one phenolic resin, with which in particular the consistency of the crosslinking agent can be adapted for the particular application. The content of phenolic resin in the crosslinking agent is preferably 0.5 to 4 wt. %, particularly preferably 0.7 to 3 wt. %, in each case based on the total weight of the crosslinking agent. The phenolic resin used in the crosslinking agent according to the invention is preferably one obtained by condensing a mixture comprising formaldehyde and phenol. The mixture particularly preferably has an excess of phenol. In particular, the molar ratio of formaldehyde to phenol in the mixture is less than 1:1.

The crosslinking agent according to the invention comprises one or more thiazole disulfide compounds. It has surprisingly been found that the addition of these compounds promotes, in particular, tolerance to bismuth compounds, such as bismuth-based catalyst systems. The proportion of the one or more thiazole disulfide compounds in the crosslinking agent according to the invention is preferably 0.3 to 7 wt. %, preferably 0.5 to 5 wt. %, in each case based on the total weight of the crosslinking agent. The one or more thiazodisulfide compounds are preferably selected from benzothiazole disulfide (MBTS) and/or zinc benzothiazole disulfide (ZMBT).

The one or more metal salts based on thiocarbamates contained in the crosslinking agent according to the invention make up preferably 0.2 to 2 wt. %, more preferably 0.4 to 1.5 wt. %, of the crosslinking agent according to the invention, in each case based on the total weight of the crosslinking agent. It has proven to be particularly advantageous if at least one of the one or more metal salts based on thiocarbamates comprises at least one zinc salt. An embodiment is therefore preferred in which at least one of the one or more metal salts based on thiocarbamates comprises at least one zinc salt, in particular zinc dibenzoylthiocarbamate.

The crosslinking agent according to the invention can also have additional components, such as fillers and additives, which serve in particular to adapt the properties of the crosslinking agent to the particular requirements. In a preferred embodiment, the crosslinking agent according to the invention also has fillers, preferably those selected from the group consisting of carbon black, calcium carbonate, coated calcium carbonate and calcium oxide. The amount of filler is preferably 40 to 70 wt. %, particularly preferably 45 to 65 wt. %, in each case based on the total weight of the crosslinking agent.

In a particularly preferred embodiment, the crosslinking agent according to the invention comprises the following:
a) elemental sulfur in an amount of 1 to 5 wt. %, preferably 1.5 to 4 wt. %;
b) one or more phenolic resins in an amount of 0.5 to 4 wt. %, preferably 0.7 to 3 wt. %;
c) one or more thiazole disulfide compounds in an amount of 0.3 to 7 wt. %, preferably 0.5 to 5 wt. %; and
d) one or more metal salts based on thiocarbamates in an amount of 0.2 to 2 wt. %, preferably 0.4 to 1.5 wt. % the stated amounts each relating to the total weight of the crosslinking agent.

The crosslinking agent according to the invention can furthermore have a polymeric component, preferably in an amount of 15 to 35 wt. %, preferably 20 to 30 wt. %, in each case based on the total weight of the crosslinking agent. The polymeric component is preferably a polymer from the group of polybutadienes, in particular a mixture of a polybutadiene and a polybutadiene-maleic anhydride adduct. The crosslinking agent particularly preferably contains a liquid polymeric component, in particular a liquid polybutadiene, preferably having a weight average molecular weight Mw of 500 to 10,000 g/mol, in particular 1,000 to 5,000 g/mol (measured by means of GPC against a polystyrene standard).

Even if the crosslinking agent according to the invention can be used in all possible technical fields, it is particularly suitable for use in vehicle construction. The present application therefore also relates to the use of the crosslinking agent according to the invention in vehicle manufacture.

The crosslinking agent according to the invention has proven to be particularly advantageous as an adhesive in the manufacture of vehicle bodies and interior fittings and has good compatibility with the electrophoretic dip processes used in vehicle manufacture, which are used, for example, for coating the body and body parts. In a preferred embodiment, the crosslinking agent according to the invention is therefore used in electrophoretic coating processes and/or in connection with “liquid applied sound deadener” (LASD). The “liquid applied sound deadener” is a liquid applied foam insulation which can significantly reduce vibrations and noises in the vehicle and which can be used to attach additional insulation material. In a further preferred embodiment, the crosslinking agent according to the invention is used in the presence of bismuth catalysts.

The present invention is explained in detail with reference to the following examples, which should not in any way be considered limiting to the inventive concept.

### EXAMPLES

The compositions summarized in Table 1 were produced, the stated amounts in each case being understood as percent by weight based on the total weight of the composition.

TABLE 1

| Component | Example 1 | Example 2 | Example 3 |
|---|---|---|---|
| Polymer | 24 | 24 | 24 |
| Filler | 64.74 | 63.74 | 62.74 |
| Phenolic resin | 0.9 | 1.9 | 2.9 |
| Sulfur | 2.5 | 2.5 | 2.5 |
| Zinc | 1.5 | 1.5 | 1.5 |
| dibenzoylthiocarbamate | | | |
| Benzothiazole disulfide | 5.0 | — | 5.0 |
| Zinc benzothiazole | — | 5.0 | — |
| disulfide | | | |
| Additives | 1.36 | 1.36 | 1.36 |
| Total | 100.00 | 100.00 | 100.00 |

The compositions of Table 1 were examined for their compatibility with customary electrophoretic coating systems, the bismuth-containing paint CathoGuard 800 from BASF SE, Germany being used as an exemplary coating. The composition was applied to a sample sheet in the form of a drop and coated with the paint. The paint was cured and assessed under the conditions given in Table 2.

Bismuth-containing Paint Compatibility Testing

TABLE 2

| Cure | 10 min; | 15 min; | 20 min; | 5 min; | 10 min; |
|---|---|---|---|---|---|
| Conditions | 165° C. | 165° C. | 165° C. | 170° C. | 170° C. |
| Rating Result | 0 | 0 | 0 | 0 | 0 |

Legend:

| Rating | Evaluation |
|---|---|
| 0 | No change in the surface |
| 1 | First signs of change |
| 3 | Bubble formation on the paint layer; no detachment |
| 5 | Detachment of the paint layer from the surface |

As can be seen from the provided data, the compositions according to the invention had excellent compatibility with common coating systems.

### Sulfur Emission Testing

Sulfur emission tests were also carried out. Test results showed the low emission tendency of the above compositions according to the invention. For this purpose, the example compositions were knife-coated onto a metal sheet in a 2 mm thick layer. The metal sheet was placed in a 1 L metal can to harden and sealed with a wet CDC sheet. The test arrangement was cured in a laboratory furnace at 105° C. for 6 minutes and 190° C. for 30 minutes, the outgoing emissions from the curing compositions reacting with the CDC coating. The concentration of sulfur on the contaminated CDC surface was then analyzed using XPS. The measurements showed a concentration of sulfur atoms in the range of 0.5 at. %.

What is claimed is:

1. A crosslinking agent for polymeric systems, comprising components:
a) elemental sulfur;
b) one or more phenolic resins;
c) one or more thiazole disulfide compounds; and
d) one or more metal salts based on thiocarbamates.

2. The crosslinking agent according to claim 1, wherein the elemental sulfur is present in an amount of 1 to 5 wt. %, based on total weight of the crosslinking agent.

3. The crosslinking agent according to claim 1, wherein component b) the one or more phenolic resins is present in an amount of 0.5 to 4 wt. % based on total weight of the crosslinking agent.

4. The crosslinking agent according to claim 1, wherein at least one of the one or more phenolic resins is obtained by condensation of a mixture comprising formaldehyde and phenol, the mixture having an excess of phenol and a molar ratio of formaldehyde to phenol of less than 1:1.

5. The crosslinking agent according to claim 1, wherein component c) the one or more thiazole disulfide compounds is present in an amount of 0.3 to 7 wt. %, based on total weight of the crosslinking agent.

6. The crosslinking agent according to claim 5, wherein the one or more thiazole disulfide compounds is selected from benzothiazole disulfide (MBTS) and/or zinc benzothiazole disulfide (ZMBT).

7. The crosslinking agent according to claim 1, wherein component d) the one or more metal salts based on thiocarbamates comprises at least zinc dibenzoyldithiocarbamate.

8. The crosslinking agent according to claim 1, wherein component d) the one or more metal salts based on thiocarbamates is present in an amount of 0.2 to 2 wt. % based on total weight of the crosslinking agent.

9. The crosslinking agent according to claim 1, wherein the crosslinking agent further comprises one or more fillers.

10. The crosslinking agent according to claim 9, wherein the one or more fillers are selected from the group consisting of carbon black, calcium carbonate and calcium oxide.

11. The crosslinking agent according to claim 1, further comprising a polymeric component.

12. The crosslinking agent according to claim 11, wherein the polymeric component is present in an amount of 20 to 50 wt. % based on total weight of the crosslinking agent.

13. The crosslinking agent according to claim 11, wherein the polymeric component is selected from polybutadienes.

14. The crosslinking agent according to claim 1, wherein based on total weight of the crosslinking agent:
component a) is present in an amount of 1.5 to 4 wt. %;
component b) is present in an amount of 0.7 to 3 wt. %;
component c) is present in an amount of 0.5 to 5 wt. %;
component d) is present in an amount of 0.4 to 1.5 wt. %;
and the crosslinking agent optionally comprises a polymeric component.

15. The crosslinking agent according to claim 14, wherein the polymeric component is present in an amount of 25 to 40 wt. % based on the total weight of the crosslinking agent.

16. A process for depositing electrophoretic dip coating and/or liquid applied sound deadener comprising steps of:
1) applying a polymeric system comprising the crosslinking agent according to claim 1, to at least a portion of a vehicle;
2) before or after or both before and after step 1), contacting the portion of the vehicle with an electrophoretic dip coating and/or a liquid applied sound deadener; and
3) heating the portion of the vehicle for a time and temperature sufficient to crosslink the polymeric system and cure the electrophoretic dip coating and/or liquid applied sound deadener.

17. The process according to claim 16, wherein the polymeric system comprising the crosslinking agent is an adhesive system and the crosslinking agent contains no more than 5 wt. % elemental sulfur.

18. The process according to claim 16, performed in the presence of bismuth catalysts.
